(19) United States
(12) Patent Application Publication
(10) Pub. No.: US 2011/0074600 A1
(43) Pub. Date: Mar. 31, 2011

(54) UTILITY REMOTE DISCONNECT FROM A METER READING SYSTEM

(75) Inventors: Mark K. Cornwall, Spokane, WA (US); Daniel R. Kritz, Newman Lake, WA (US); Christopher J. Wykle, Burlington, KY (US)

(73) Assignee: ITRON, INC., Liberty Lake, WA (US)

(21) Appl. No.: 12/891,091

(22) Filed: Sep. 27, 2010

Related U.S. Application Data
(60) Provisional application No. 61/247,070, filed on Sep. 30, 2009.

(51) Int. Cl. G08B 1/00

(52) U.S. Cl. 340/870.02

(57) ABSTRACT

Disclosed are apparatus and methodology for providing remote gas disconnection by way of a meter reading system. In accordance with the present subject matter, a gas metering device is provided with a remotely controllable valve, and a handheld or mobile device (normally employed to collect data such as normal meter readings generally associated with utility consumption) is configured to transmit disconnect instructions to a selected gas metering device as a meter reader proceeds along a route. In an alternative embodiment, disconnect instructions may be sent directly to a remotely operable valve equipped metering device by way of a fixed network meter reading system.

### PRIORITY CLAIM

This application claims the benefit of previously filed U.S. Provisional Patent Application entitled “GAS REMOTE DISCONNECT FROM A METER READING SYSTEM,” assigned U.S. Ser. No. 61/247,070, filed Sep. 30, 2009, and which is incorporated herein by reference for all purposes.

### FIELD OF THE INVENTION

The present subject matter relates to utility, including gas supply devices. More particularly, the present subject matter relates to remote gas shut-off apparatus and methodologies.

### BACKGROUND OF THE INVENTION

Utility companies perform a critically important task of providing needed commodities (i.e., utilities) such as electrical power, gas, water, and others to businesses and households. Such commodities not only make possible desired comfort but provide a truly fundamental cornerstone of modern living. In turn, processes have evolved in response to demand/need for ever increasing efficient reading and interaction with meters installed at such locations, to facilitate requisite and appropriate billing for the services of providing such commodities. Such efforts have more recently evolved from expensive, time-consuming personnel-intensive efforts, requiring on-site inspection and/or handling of meter issues and related concerns, to relatively more remotely controlled events and servicing.

The need for such “remote” activities, whether meter reading or adjunct meter and/or commodities management, have grown both in scope and type. In other words, not only is it desired to remotely detect meter readings and conduct activities adjunct thereto, but also to detect and manage equipment malfunctions, whether occurring naturally (such as storm related), or occurring intentionally (such as in meter tampering or commodities theft). It is also highly desirable to provide systems and controls which can prevent problems before they happen and/or provide relatively early detection and effective management.

In many instances, the prospect of equipment malfunction (whether through tampering, accidents, or longevity/maintenance failures) can raise serious safety issues inherent to the commodities being delivered/managed on-site. For example, emergencies may arise due to gas leakages, or fires, whether originated from gas, electrical, or other sources. In fact, a number of potential safety problems are well known in the industry. Accordingly, management and control of metering systems and related delivering a variety of commodities remains an important area of interest from a safety perspective, particularly as industry and societal needs drive requirements for ever-increasing remotely-based activities/management.

Various patents and patent applications provide disclosures directed to gas or fluid metering or distribution systems that may include aspects relating to shut off valve control or management. For example, U.S. Pat. No. 7,088,239 to Basinger et al. discloses an apparatus for routine monitoring and automatic reporting of electrical power and gas utility usage that also provides means for detecting and reporting to the relevant utility companies the development of local hazards on premises at which one or more utility usage meters are installed. The system includes a remote computer capable of turning on or off the supply of gas at the meter, perhaps as a result of the utility user not having made timely payments for the usage of gas. The meter has the capability to send a return or confirmation signal to the remote computer to confirm that the supply of gas has been shut off.

U.S. Pat. No. 6,892,751 to Sanders discloses a building protection system, involving the transmission of signals to LED's to indicate whether the shutoff valve is in the open or closed position. U.S. Pat. No. 6,470,903 to Reyman discloses an automatically actuated regulation system for a natural gas pipeline, which involves reporting the position of a shutoff valve, whether open or closed, to the utility company through a signal. The utility company may communicate remotely through a modem to actuate such shutoff valve.

U.S. Pat. No. 6,000,931 to Tanabe et al. discloses a gas safety control system for supplying a gas that is forwarded from a gas supply source through an inspection meter to one or more gas appliances, involving the output of cutoff information indicating that the supply of gas is cut off by a cut off valve.

U.S. Patent Application Publication No. 2006/0278269 to McGill discloses a safety valve that is positioned in supply plumbing that supplies a fluid medium such as natural gas to a point of use structure such as a home. A mechanical actuator is provided remote from the safety valve but mechanically connected to the safety valve. The mechanical actuator can be actuated by seismic disturbance, manually, or by activation by remote sensor or home security system. The actuator provides a status viewer for viewing the status of the valve (either ON or OFF). The system does not transmit the status indicator to a remote location.

U.S. Pat. No. 7,458,387 to McGill is directed to an emergency gas and electricity cutoff apparatus and control system, including a gas meter having a gas flow shut off valve. The system includes a controller remote from the gas flow shut off valve that is capable of sending a gas flow shut off signal to the shutoff valve. A valve shut-off signal may be sent from a controller to the valve for activation, through use of a wire or by RF.

U.S. Pat. No. 6,056,008 to Adams et al. discloses an intelligent pressure regulator for maintaining a fluid in a process at a predetermined pressure that includes an electronic controller which enhances regulator performance and provides self-diagnostics and communications capabilities. The regulator can be adapted to receive through the communications circuit an electrical signal representing a desired pressure of the process fluid and to store a digital representation of that electrical signal in the memory. U.S. Pat. No. 7,064,671 to Vanderah et al. discloses a pressure regulator with wireless communications capabilities. The regulator includes various methods of conserving the amount of power consumed by the pressure regulator system.

The disclosures of all such patent related publications referenced herein are fully incorporated herein by reference for all purposes.

While various implementations of gas shut-off apparatus and methodologies have been developed, and while various combinations of data collection and/or transmission systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, improved apparatus and methodologies for providing remote disconnection of a gas consumer by way of a meter reading system and/or functionality has been provided.

In an exemplary configuration, a present exemplary remotely operable valve has been advantageously associated with a gas metering device.

In one of their simpler forms, an exemplary present remotely operable valve has been incorporated into a gas metering device.

Another positive aspect of exemplary embodiments of the present type of device is that gas utility services may easily be remotely disconnected without necessarily having to send equipment and personnel to the gas consumption location.

In accordance with aspects of certain embodiments of the present subject matter, methodologies are provided to provide gas disconnection (for whatever reason, for example, either late payments or vacant house) by a meter reader as a part of reading meters along a route.

In accordance with further aspects of other embodiments of the present subject matter, methodologies are provided to remotely disconnect selected gas utilities by way of disconnection commands sent over a fixed network meter reading system.

It should be appreciated by those of ordinary skill in the art from the complete disclosure herewith that the present subject matter is intended to equally encompass both devices and associated methodologies.

One exemplary embodiment of the present subject matter relates to an advanced meter reading system for transmitting between user locations and a centralized data collection facility data and commands related to utility usage and utility supply connections. Such an exemplary present system preferably comprises a plurality of utility metrology means and associated endpoint devices, situated at respective locations of utility consumption, for transmitting utility consumption data associated with a respective location; at least one disconnect means, associated with at least one of such utility metrology means and its associated endpoint device, for disconnecting a utility supply associated with such at least one utility metrology means at its respective location in response to a disconnect signal transmitted to such disconnect means; a main communications network for bidirectional communications with such endpoint devices; and a head end processor for bidirectional communications with such main communications network, such that utility consumption data and disconnect signal commands, respectively, are communicated to and from such head end processor via such main communications network.

In some present variations of the foregoing, such systems may further include at least one collector, for bidirectional communications with such endpoint devices and such main communications network; and a plurality of disconnect means, respectively associated with selected of such endpoint devices, for respectively disconnecting a utility supply associated with such endpoint device locations in response to respective disconnect signals transmitted thereto. Further, in different alternatives, such utility consumption may comprise one of gas, water, and electricity consumption.

Other present alternatives may further include a plurality of disconnect means, respectively associated with selected of such endpoint devices, for respectively disconnecting a utility supply associated with such endpoint device locations in response to respective disconnect signals transmitted thereto, while such utility consumption may comprise gas consumption; and such utility metrology means may comprise respective gas meters.

In yet other alternatives, such utility supply may comprise a gas line associated with such utility consumption locations; and such disconnect means may respectively comprise disconnect valves inline with such supply gas line and associated with its respective endpoint device. In some such alternative advanced meter reading systems, at least some of such disconnect valves may be respectively located inside of associated utility metrology means. In others, they may be respectively located outside of associated utility metrology means.

A further present alternative is to further include with a present advanced meter reading system a mobile device in RF communication with other components of such system, for controllably receiving utility consumption data and sending disconnect signal commands.

In some present arrangements, such utility consumption may comprise gas consumption; and such system may further include a plurality of telemetry devices respectively associated with a plurality of utility consumption locations, each of such telemetry devices monitoring for a preselected condition at its respective location, and transmitting data to such head end processor related to such preselected condition. In variations of the foregoing, such telemetry devices respectively may include alarm means for forwarding alarm signaling to such head end processor whenever monitored conditions thereat fall outside set parameters.

In other present alternative advanced meter reading systems, such head end processor may further include data management functionality, for storing and processing utility consumption data; and such main communications network may comprise one of a WAN, a wireless network, and the Internet. In yet others, present advanced meter reading systems may further include at least one collector, for bidirectional communications with such endpoint devices and such main communications network; a plurality of disconnect means, respectively associated with selected of such endpoint devices, for respectively disconnecting a utility supply associated with such endpoint device locations in response to respective disconnect signals transmitted thereto; and a mobile device in RF communication with other components of such system, for controllably receiving utility consumption data and sending disconnect signal commands; wherein such utility consumption may comprise gas consumption; such utility metrology means may comprise respective gas meters; such utility supply may comprise a gas line associated with such utility consumption locations; such disconnect means may respectively comprise disconnect valves inline with such supply gas line and associated with its respective endpoint device; such head end processor may further include data management functionality, for storing and processing utility consumption data; and such main communications network may comprise one of a WAN, a wireless network, and the internet.

Another present exemplary embodiment in accordance with the subject technology relates to a bidirectional gas AMI network for transmitting commands and gas usage data between user locations and a centralized data collection facility, such network preferably comprising a plurality of combined gas metrology/endpoint devices for obtaining and transmitting gas usage data associated with its respective location; a plurality of disconnect valve means, respectively associated with selected of such endpoint devices, for respectively disconnecting a utility supply associated with such endpoint device locations in response to respective disconnect signals transmitted thereto; a WAN; a plurality of data collection devices, for bidirectional communications with selected of such metrology/endpoint devices and such WAN; and a centralized data collection facility in bidirectional communication with such WAN, for receiving and processing gas usage data, and for selectively transmitting respective disconnect signals to targeted endpoint device locations for terminating utility supply thereat.

Variations of the foregoing may further include a supply gas line associated with such gas metrology/endpoint locations; and wherein such disconnect valve means may respectively comprise disconnect valves inline with such supply gas line and associated with its respective endpoint device.

Other present alternatives may further include a mobile device in RF communication with other components of such network, for controllably receiving gas usage data and sending disconnect signal commands. Yet others may further include meter data management means associated with such centralized data collection facility, for storing and processing data received via such network.

Present exemplary methodology in accordance with the present subject matter my relate to a method for gathering data for monitoring gas consumption associated with a gas pipeline of a gas utility provider, and for selectively disconnecting gas supplies at selected locations, using a single integrated network system. Preferably, such present exemplary method may comprise transmitting gas consumption data from a plurality of endpoint devices associated with respective locations of gas utility usage; transmitting the gas consumption data to at least one collector; communicating such data to a head end processor via such collector and a main communications network; and selectively transmitting disconnect signal commands from such head end processor to disconnect valves at selected locations of gas utility usage, to disconnect such locations from an associated gas supply. Per such methodology, advantageously gas consumption data are collected and communicated to a central location for processing, and disconnect signal commands are communicated via the same network as such data, to permit efficient monitoring and control of gas utility usage and associated gas supply by a gas utility provider.

In present variations of such methodology, such disconnect step may include selected activation of controllable valves operatively associated inline with selected sections of a supply gas pipeline, respectively associated with such selected locations.

In other present variations, such methodology may further include using a mobile device in RF communication with other components of such network, for controllably receiving gas consumption data and for sending disconnect signal commands. Per yet other alternatives, present exemplary methodology may further include conducting data management at the central location, for storing and processing gas consumption data; and wherein the network at least in part may comprise one of a WAN, a wireless network, and the internet.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figure, in which:

FIG. 1 is a block diagram of an exemplary Advanced Metering System (AMS) usable in accordance with the present subject matter for remote disconnection functionality and related;

FIG. 2 illustrates a representative block diagram overview of a portion of an exemplary Advanced Metering System (AMS) including an associated handheld or mobile device and such device's operational relationship with the AMS; and

FIG. 3 is a general representation of a gas metering device incorporating a remotely controllable disconnect valve in accordance with present technology.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with apparatus and methodologies for providing remote disconnection of a gas consumer by way of a meter reading system and/or related functionality.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

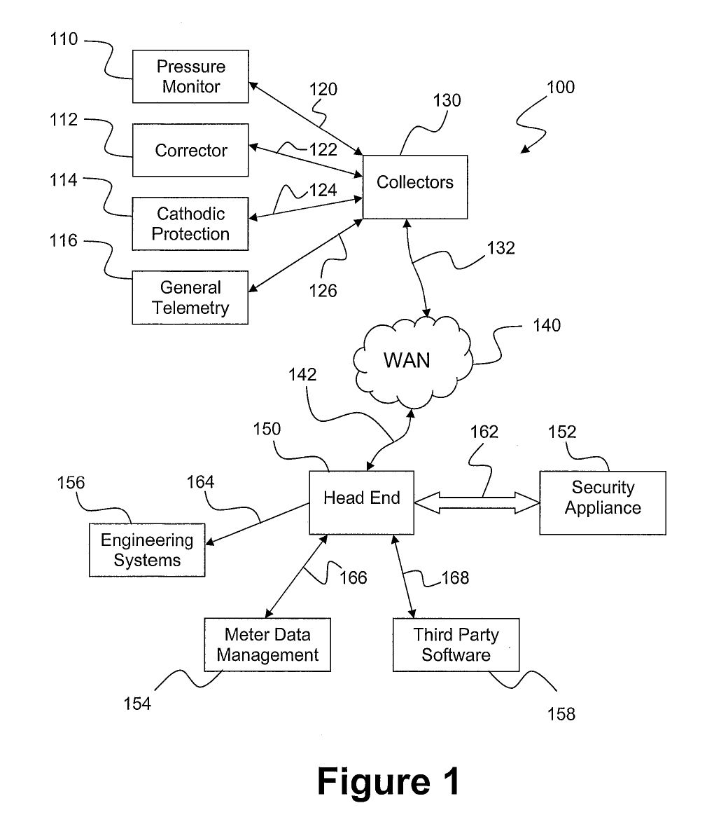

Reference is made in detail to the presently preferred embodiments of a subject telemetry system with which communications of the present subject matter may be practiced. Referring now to the drawings, FIG. 1 illustrates an exemplary telemetry system generally 100, which may include various exemplary telemetry endpoints 110, 112, 114, and 116 located within, for example, a Gas AMI network, and which are read by network collectors 130. Telemetry endpoints may include, but are not limited to, a pressure monitor 110, a data corrector 112, cathodic protection apparatus 114, and general telemetry apparatus 116. Such exemplary telemetry endpoints 110, 112, 114, and 116 may be connected for data transmission via transmission paths 120, 122, 124, and 126, respectively, to collectors 130.

It should be appreciated that while transmission paths 120, 122, 124, and 126 are presently illustrated as transmission lines, such is not a specific limitation of the present technology as data may be transmitted by any suitable technology, including via wired as well as wireless technology. In similar fashion, transmission paths 162, 164, 166, and 168 (illustrated as variously coupled data between head end associated items) may also correspond to any suitable data transmission capable device or methodology, now existing or later developed.

Those of ordinary skill in the art will appreciate that the illustration in FIG. 1 with respect to the network configuration is exemplary and that other components, for example, but not limited to, repeaters, may also be employed. It should be appreciated that while the present subject matter is described more specifically as directed to gas AMI networks, such is not a specific limitation of the disclosure as the present disclosure may be extended to water and electric networks, as applicable, particularly as to selected portions of the present disclosure.

Further, while the present communications system is described as a network, other and additional communication forms including the use of mobile data collection apparatus may be employed within the scope of the present disclosure. Still further, while the present disclosure describes the use of a WAN to transmit information (either data or instructions) among selected devices, such is illustrative only as other information exchange apparatus may be used to provide desired communications including, but not limited to, WAN's, LAN's, all varieties of wireless systems, and the Internet, and intended to include other later developed technologies.

In accordance with present exemplary disclosure, information from such exemplary endpoints 110, 112, 114, and 116 may be processed in the collectors 130 and sent over a WAN generally 140 to a head end system generally 150 by way of exemplary transmission paths 132, 142. The head end system 150 may further process the endpoint reading or data and send that information to other systems. Long-term storage can, of course, be provided by, for example, a meter data management (MDM) system generally 154, not presently illustrated in detail, and details of which form no particular aspect of the present subject matter. Such system 154 may also be considered as meter data management means associated with the head end or centralized data collection facility, for storing and processing data received via the telemetry system generally 100. For telemetry, there may be other systems that are not part of an AMR/AMI network, such as engineering systems generally 156 that monitor distribution system pressure, or software systems generally 158 provided by the manufacturer of the correctors 112 or other components monitored by the endpoints. Other systems, not presently illustrated, may also be included in system 100. Also, the representative endpoints 110, 112, 114, and 116 are intended to be understood by those of ordinary skill in the art as representing any number of such endpoints in use in a given system configuration in accordance with present subject matter, variously and respectively associated with collectors as needed.

Endpoints 110, 112, 114, and 116 “bubble-up” readings of the telemetry data periodically as needed for measurement resolution and network reliability. As described, for example, in U.S. Pat. No. 7,298,288 B2, assigned to the owner of the present technology, battery-powered endpoints have been designed to limit the power consumed in day-to-day operation. One known design feature is a bubble-up mode of operation, in which an endpoint “bubbles-up,” or activates its transceiver to communicate or attempt to communicate with the AMR data collection system, according, for example, to a preset schedule. The time duration or period between bubble-up events may typically span seconds or minutes.

Endpoints 110, 112, 114, and 116 may also contain alarm thresholds. Per the present subject matter, when such thresholds are exceeded, the associated endpoint will initiate an alarm to relatively rapidly indicate an over/under threshold situation to the head end 150. Such alarms may take the form of special messages and may be sent at a higher frequency than normal transmissions to ensure rapid and reliable delivery. Parameters stored in collectors 130 may also be changed through the use of two-way commands from the system head end 150 down to the collectors. Thought of in different terms, it is to be understood that all such various alarm features may be considered as being alarm means for forwarding alarm signaling whenever monitored conditions thereat fall outside set parameters (whether initially set or subsequently reset).

Collectors 130 validate the readings from the endpoints 110, 112, 114, and 116 and prioritize the uploading of data to the head end 150. Collectors 130 can also evaluate data from the endpoints 110, 112, 114, and 116 and generate alarms as well, per the present subject matter.

At head end 150, data is further validated, alarms may also be generated, and alarms and data are exported to an external system. Head end 150 can also accept requests from an external system (not presently illustrated) to send reconfiguration messages through the network to the endpoints 110, 112, 114, and 116, all per the present subject matter.

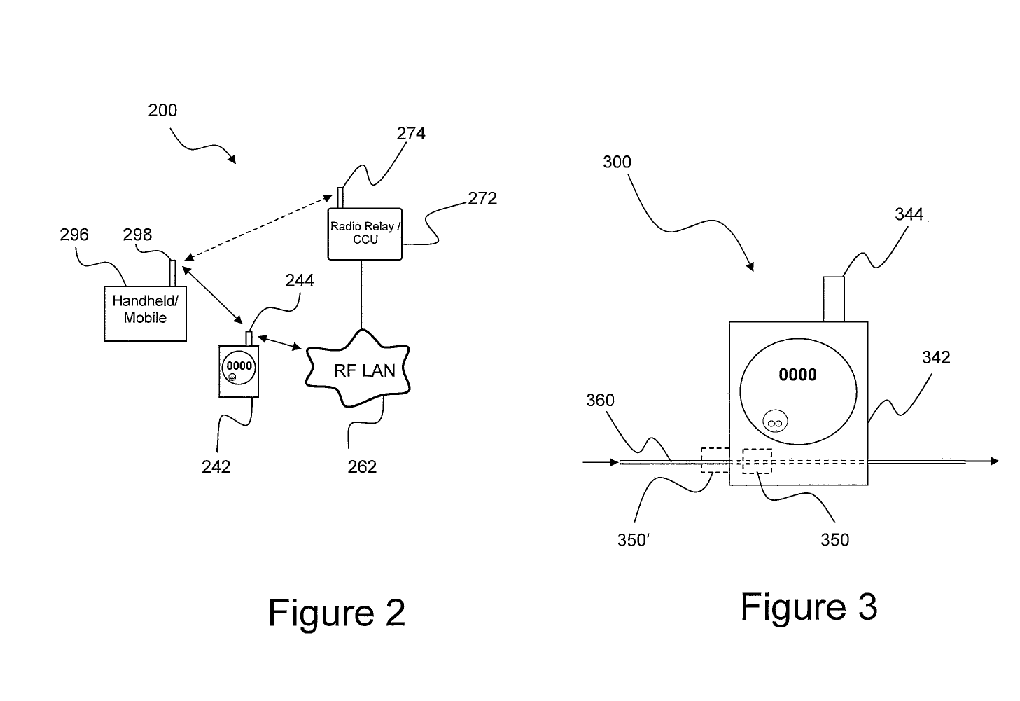

With reference now to FIG. 2, there is illustrated a representative block diagram overview of a portion of an exemplary Advanced Metering System (AMS) generally 200 including an associated handheld or mobile device 296 and such device's operational relationship with the AMS 200. AMS 200 may include, without limitation, a Radio Relay or Cell Control Unit (CCU) generally 272 configured to communicate via internal radio circuitry (not separately illustrated) and a representative external antenna 274 with WAN 140 (FIG. 1), which may correspond at least in part with RF LAN generally 262. RF LAN 262 is configured to communicate by radio frequency transmissions with, inter alia, metrology device 242 by way of an associated endpoint device and associated antenna 244 (which together with related functionality may also be regarded as being utility metrology means).

Also illustrated in representative FIG. 2 is a handheld or mobile device generally 296 that is configured per the present subject matter to perform multiple tasks including meter reading operations as well as instructional transmissions of commands by way of internal radio transmission circuitry (not separately illustrated) and a representative external antenna 298. Handheld or mobile device 296 may also engage in the transmission of other relevant information to and from both metrology device 242 and WAN 140 (FIG. 1) by way of RF LAN 262 and Radio Relay/CCU 272.

In accordance with present technology, metrology device 242 may be provided with a shut off valve, as more fully illustrated in present FIG. 3. Referring now to FIG. 3, there is illustrated a gas metering system 300 including a metering device 342 that incorporates a disconnect valve 350, 350′ (which may be thought of in other terms with related functionality as constituting disconnect means, associated with at least one of the utility metrology means and its associated endpoint device, for disconnecting a utility supply associated with the at least one utility metrology means at its respective location in response to a disconnect signal transmitted to the disconnect means). Further, those disconnect means associated with a gas supply system and having a valve associated with a gas pipeline may be understood as comprising disconnect valve means. In an exemplary embodiment, valve 350 may be incorporated inside metering device 342 so as to be inline with gas line 360 as such line 360 enters and exits metrology device 342. In an alternative embodiment, valve 350′ may be located on (or external to) metrology device 342 but still coupled inline with line 360 in order to control gas supply to a consumer. Alternatively still, valve 350 may be associated with other non-metrology devices such as, but not limited to, a pressure regulator device. In all of such instances, all encompassed by the present subject matter, an endpoint communications device will be associated with the valve or its hosting device in order to permit communications therewith in accordance with present technology.

Those of ordinary skill in the art will appreciate that communication from head end 150 may be by way of RF communications to an endpoint, for example general telemetry endpoint 116, that may be associated with or incorporated in metrology device 242 over a fixed network as generally illustrated in FIG. 1. Alternatively, communications may be provided in whole or in part by other communications methodologies including, but not limited to all types of wired and wireless communications or combinations thereof, now or later existing.

In accordance with present technology, if the need arises to disconnect a gas utility customer at a particular location, be it for delinquency, location vacancy, or other reasons, such disconnection may be effected by way of a data collection device such as handheld or mobile device 296. Further, in accordance with present technology, disconnection may be performed via handheld or mobile device 296 as part of the normal process of collecting (reading) data along a particular route. Similarly, and further in accordance with present technology, disconnection may be accomplished by transmission of disconnect instruction to a specific endpoint device associated with a particular meter and transmitted to such endpoint device by way of a fixed network metering system such as the Advanced Metering System generally 100 exemplarily illustrated in FIG. 1 (or via some other form of network or communications technique, now or later existing).

In light of such present advances in the art, gas utilities are enabled for significant savings in manpower and expenses by performing required or desired disconnections as a part of regular data collection activities or from a central location, as either required or desired, without having to dispatch any equipment or personnel to the disconnection location or locations.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An advanced meter reading system for transmitting between user locations and a centralized data collection facility data and commands related to utility usage and utility supply connections, said system comprising:
a plurality of utility metrology means and associated endpoint devices, situated at respective locations of utility consumption, for transmitting utility consumption data associated with a respective location;
at least one disconnect means, associated with at least one of said utility metrology means and its associated endpoint device, for disconnecting a utility supply associated with said at least one utility metrology means at its respective location in response to a disconnect signal transmitted to said disconnect means;
a main communications network for bidirectional communications with said endpoint devices; and
a head end processor for bidirectional communications with said main communications network, such that utility consumption data and disconnect signal commands, respectively, are communicated to and from said head end processor via said main communications network.

2. An advanced meter reading system as in claim 1, further including:
at least one collector, for bidirectional communications with said endpoint devices and said main communications network; and
a plurality of disconnect means, respectively associated with selected of said endpoint devices, for respectively disconnecting a utility supply associated with such endpoint device locations in response to respective disconnect signals transmitted thereto;
wherein said utility consumption comprises one of gas, water, and electricity consumption.

3. An advanced meter reading system as in claim 1, further including:
a plurality of disconnect means, respectively associated with selected of said endpoint devices, for respectively disconnecting a utility supply associated with such endpoint device locations in response to respective disconnect signals transmitted thereto;
wherein said utility consumption comprises gas consumption; and
said utility metrology means comprise respective gas meters.

4. An advanced meter reading system as in claim 3, wherein:
said utility supply comprises a gas line associated with said utility consumption locations; and
said disconnect means respectively comprise disconnect valves inline with such supply gas line and associated with its respective endpoint device.

5. An advanced meter reading system as in claim 4, wherein at least some of said disconnect valves are respectively located inside of associated utility metrology means.

6. An advanced meter reading system as in claim 4, wherein at least some of said disconnect valves are respectively located outside of associated utility metrology means.

7. An advanced meter reading system as in claim 1, further including a mobile device in RF communication with other components of said system, for controllably receiving utility consumption data and sending disconnect signal commands.

8. An advanced meter reading system as in claim 1, wherein:
said utility consumption comprises gas consumption; and
said system further includes a plurality of telemetry devices respectively associated with a plurality of utility consumption locations, each of said telemetry devices monitoring for a preselected condition at its respective location, and transmitting data to said head end processor related to such preselected condition.

9. An advanced meter reading system as in claim 8, wherein said telemetry devices respectively include alarm means for forwarding alarm signaling to said head end processor whenever monitored conditions thereat fall outside set parameters.

10. An advanced meter reading system as in claim 1, wherein:
said head end processor further includes data management functionality, for storing and processing utility consumption data; and
said main communications network comprises one of a WAN, a wireless network, and the internet.

11. An advanced meter reading system as in claim 1, further including:
at least one collector, for bidirectional communications with said endpoint devices and said main communications network;
a plurality of disconnect means, respectively associated with selected of said endpoint devices, for respectively disconnecting a utility supply associated with such endpoint device locations in response to respective disconnect signals transmitted thereto; and
a mobile device in RF communication with other components of said system, for controllably receiving utility consumption data and sending disconnect signal commands;
wherein said utility consumption comprises gas consumption;
said utility metrology means comprise respective gas meters;
said utility supply comprises a gas line associated with said utility consumption locations;
said disconnect means respectively comprise disconnect valves inline with such supply gas line and associated with its respective endpoint device;
said head end processor further includes data management functionality, for storing and processing utility consumption data; and
said main communications network comprises one of a WAN, a wireless network, and the internet.

12. A bidirectional gas AMI network for transmitting commands and gas usage data between user locations and a centralized data collection facility, said network comprising:
a plurality of combined gas metrology/endpoint devices for obtaining and transmitting gas usage data associated with its respective location;
a plurality of disconnect valve means, respectively associated with selected of said endpoint devices, for respectively disconnecting a utility supply associated with such endpoint device locations in response to respective disconnect signals transmitted thereto;
a WAN;
a plurality of data collection devices, for bidirectional communications with selected of said metrology/endpoint devices and said WAN; and
a centralized data collection facility in bidirectional communication with said WAN, for receiving and processing gas usage data, and for selectively transmitting respective disconnect signals to targeted endpoint device locations for terminating utility supply thereat.

13. A network as in claim 12, further including:
a supply gas line associated with said gas metrology/endpoint locations; and
wherein said disconnect valve means respectively comprise disconnect valves inline with such supply gas line and associated with its respective endpoint device.

14. A network as in claim 12, further including a mobile device in RF communication with other components of said network, for controllably receiving gas usage data and sending disconnect signal commands.

15. A network as in claim 12, further including meter data management means associated with said centralized data collection facility, for storing and processing data received via said network.

16. A method for gathering data for monitoring gas consumption associated with a gas pipeline of a gas utility provider, and for selectively disconnecting gas supplies at selected locations, using a single integrated network system, such method comprising:
transmitting gas consumption data from a plurality of endpoint devices associated with respective locations of gas utility usage;
transmitting the gas consumption data to at least one collector;
communicating such data to a head end processor via such collector and a main communications network; and
selectively transmitting disconnect signal commands from such head end processor to disconnect valves at selected locations of gas utility usage, to disconnect such locations from an associated gas supply, whereby gas consumption data are collected and communicated to a central location for processing, and disconnect signal commands are communicated via the same network as such data, to permit efficient monitoring and control of gas utility usage and associated gas supply by a gas utility provider.

17. A method as in claim 16, wherein such disconnect step includes selected activation of controllable valves operatively associated inline with selected sections of a supply gas pipeline, respectively associated with such selected locations.

18. A method as in claim 16, further including using a mobile device in RF communication with other components of such network, for controllably receiving gas consumption data and for sending disconnect signal commands.

19. A method as in claim 16, further including:
conducting data management at the central location, for storing and processing gas consumption data; and
wherein the network at least in part comprises one of a WAN, a wireless network, and the Internet.
